(19) United States
(12) Patent Application Publication
(10) Pub. No.: US 2024/0032707 A1
(43) Pub. Date: Feb. 1, 2024

(54) SMART FURNITURE NETWORK AND MOTION CONTROL SYSTEM

(71) Applicant: La-Z-Boy Incorporated, Monroe, MI (US)

(72) Inventors: Robert B. WOMACK, Chattanooga, TN (US); Chandrasekar RAMASUBRAMANIAN, Dayton, TN (US)

(73) Assignee: La-Z-Boy Incorporated, Monroe, MI (US)

(21) Appl. No.: 18/222,528

(22) Filed: Jul. 17, 2023

Related U.S. Application Data
(60) Provisional application No. 63/393,562, filed on Jul. 29, 2022.

(51) Int. Cl. A47C 31/00; G05B 15/02

(52) U.S. Cl. CPC A47C 31/008; G05B 15/02; G05B 2219/2642

(57) ABSTRACT

A smart furniture motion control system for controlling movement of one or more movable parts of a first furniture member includes one or more actuators configured to control movement of the one or more movable parts of the first furniture member; a Wi-Fi circuit configured to send and receive wireless signals; and control circuitry configured to control the one or more actuators, wherein the control circuitry is configured to, in response to receiving a smart furniture control signal from a cloud network via the Wi-Fi circuit, drive the one or more actuators such that the one or more movable parts move in accordance with one or more operations specified by the smart furniture control signal.

### CROSS-REFERENCE TO RELATED APPLICATIONS

This application claims the benefit of U.S. Provisional Application No. 63/393,562, filed on Jul. 29, 2022. The entire disclosure of the above application is incorporated herein by reference.

### FIELD

The present disclosure relates to a network and system for controlling operations of furniture member.

### BACKGROUND

This section provides background information related to the present disclosure and is not necessarily prior art.

Furniture members (e.g., chairs, sofas, loveseats, etc.) can include, for example, movable legrests, headrests, lumbar mechanisms and/or seatbacks. For example, the legrests, headrests, and lumbar mechanisms can be extended and retracted and the seatbacks can be reclined. Some furniture members include electric motors that drive movement of the furniture members in response to control input from a user.

### SUMMARY

This section provides a general summary of the disclosure and is not a comprehensive disclosure of its full scope or all of its features.

According to at least some example embodiments, a smart furniture motion control system for controlling movement of one or more movable parts of a first furniture member includes one or more actuators configured to control movement of the one or more movable parts of the first furniture member; a Wi-Fi circuit configured to send and receive wireless signals; and control circuitry configured to control the one or more actuators, wherein the control circuitry is configured to, in response to receiving a smart furniture control signal from a cloud network via the Wi-Fi circuit, drive the one or more actuators such that the one or more movable parts move in accordance with one or more operations specified by the smart furniture control signal.

The control circuitry may be configured such that, in response to the smart furniture control signal indicating an operation of moving a first movable part from among the one or more movable parts of the first furniture member to a first position, the control circuitry drives the actuator such that the first movable part moves to the first position.

The system may further include a memory, wherein the control circuitry may be configured such that, in response to the smart furniture control signal indicating an operation of storing at least one current position of at least one movable part from among the one or more movable parts of the first furniture member as a preset, the control circuitry stores the at least one current position of the at least one movable part as a preset in the memory.

The control circuitry may be configured such that, in response to the smart furniture control signal indicating a stop motion operation, the control circuitry stops driving the actuator such that movement of the one or more movable parts of the first furniture member ceases.

The control circuitry may be configured such that, in response to the smart furniture control signal indicating an operation of finding a remote, the control circuitry transmits, to the remote, a signal for causing the remote to generate an audible sound and/or a visible flashing light pattern.

A smart furniture member may include a seatback; a seat bottom; a frame; at least one movable legrest platform, headrest platform, lumbar platform, or back recline mechanism that is supported by the frame and movable relative to the frame; and the smart furniture motion control system, wherein the smart furniture member is the first furniture member.

The furniture member may further include a heater, and the control circuitry may be configured such that, in response to the smart furniture control signal indicating an operation of starting a heating function, the control circuitry controls the heater to turn on.

The control circuitry may be configured such that, in response to the smart furniture control signal indicating an operation of increasing a level of the heating function, the control circuitry controls the heater to provide more heat.

The control circuitry may be configured such that, in response to the smart furniture control signal indicating an operation of lowering a level of the heating function, the control circuitry controls the heater to provide less heat.

The control circuitry may be configured such that, in response to the smart furniture control signal indicating an operation of providing the heating function at a specified level from among a plurality of levels, the control circuitry controls the heater to provide an amount of heat corresponding to the specified level.

The furniture member may further include a massager, and the control circuitry may be configured such that, in response to the smart furniture control signal indicating an operation of starting a massage function, the control circuitry controls the massager to turn on.

The control circuitry may be configured such that, in response to the smart furniture control signal indicating an operation of increasing a level of the massage function, the control circuitry controls the massager to increase an intensity of the massage function.

The control circuitry is configured such that, in response to the smart furniture control signal indicating an operation of decreasing a level of the massage function, the control circuitry controls the massager to decrease an intensity of the massage function.

The control circuitry may be configured such that, in response to the smart furniture control signal indicating an operation of providing the massage function at a specified level from among a plurality of different levels, the control circuitry controls the massager to provide the massage function with an intensity that corresponds to the specified level.

The control circuitry may be configured such that, in response to the smart furniture control signal indicating an operation of providing the massage function with a specified massage pattern from among a plurality of different massage patterns, the control circuitry controls the massager to provide the massage function with the specified massage pattern.

According to at least some example embodiments, a cloud network includes memory storing computer-executable instructions; and one or more processors configured to execute the computer-executable instructions, wherein the computer-executable instructions include receiving a first command indicating a requested operation of a smart furniture member; generating, based on the requested operation of the first command, one or more smart furniture control signals for controlling the smart furniture member; and transmitting the one or more smart furniture control signals to the smart furniture member.

The receiving of the first command may include receiving the first command via the internet.

The first command may be an app command received from a user device running a smart furniture app.

The first command may be a voice command received from a smart speaker device.

The of transmitting of the one or more smart furniture control signals to the smart furniture member may include transmitting the one or more smart furniture control signals to the smart furniture member via the internet.

The generated one or more smart furniture control signals may be control signals for controlling the smart furniture member to move a first movable part, from among one or more movable parts of the smart furniture member, to a first position, and the first movable part and the first position may be indicated by the first command.

The generated one or more smart furniture control signals may be control signals for controlling the smart furniture member to store at least one current position of at least one movable part from among one or more movable parts of the smart furniture member as a preset in a memory of the smart furniture member.

The generated one or more smart furniture control signals may be control signals for controlling the smart furniture member to cease movement of one or more movable parts of the smart furniture member.

The generated one or more smart furniture control signals may be control signals for controlling the smart furniture member to perform a remote finding operation.

The generated one or more smart furniture control signals may be control signals for controlling the smart furniture member to start a heating function.

The one or more smart furniture control signals may indicate an operation of increasing a level of the heating function.

The one or more smart furniture control signals may indicate an operation of lowering a level of the heating function.

The one or more smart furniture control signals may indicate an operation of providing the heating function at a specified level from among a plurality of levels.

The generated one or more smart furniture control signals may be control signals for controlling the smart furniture member to start a massage function.

The one or more smart furniture control signals may indicate an operation of increasing a level of the massage function.

The one or more smart furniture control signals may indicate an operation of decreasing a level of the massage function.

The one or more smart furniture control signals may indicate an operation of providing the massage function at a specified level from among a plurality of different levels.

The one or more smart furniture control signals may indicate an operation of providing the massage function with a specified massage pattern from among a plurality of different massage patterns. The massage patterns could include a wave pattern (i.e., a pattern that travels along the user's body when seated in the furniture member), a pulsing pattern (where various massaging motors pulse on and off or alternatingly increase and decrease intensity), and/or user-defined (or user-created) custom patterns.

### BRIEF DESCRIPTION OF THE DRAWINGS

The drawings described herein are for illustrative purposes only of selected embodiments and not all possible implementations and are not intended to limit the scope of the present disclosure.

FIG. 1A illustrates a portion of a smart furniture internet of things (IoT) network according to at least some example embodiments.

FIG. 1B is an example for explaining the generation of smart furniture control signals in the smart furniture IoT network of FIG. 1A according to at least some example embodiments.

FIG. 2 illustrates a block diagram of a network element according to at least some example embodiments.

FIGS. 3A-3C illustrate examples of a smart furniture member included in the smart furniture IoT network of FIGS. 1A and 1B.

FIG. 4A is a block diagram of an example implementation of a furniture control module according to the principles of the present disclosure.

FIG. 4B is a block diagram of another example implementation of a furniture control module according to the principles of the present disclosure.

FIGS. 5A-5C are block diagrams of examples of smart furniture motion control systems which may be included in the smart furniture members of FIGS. 1A, 1B, and 3A-3C.

FIG. 6 illustrates a block diagram of an example of a connect box.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

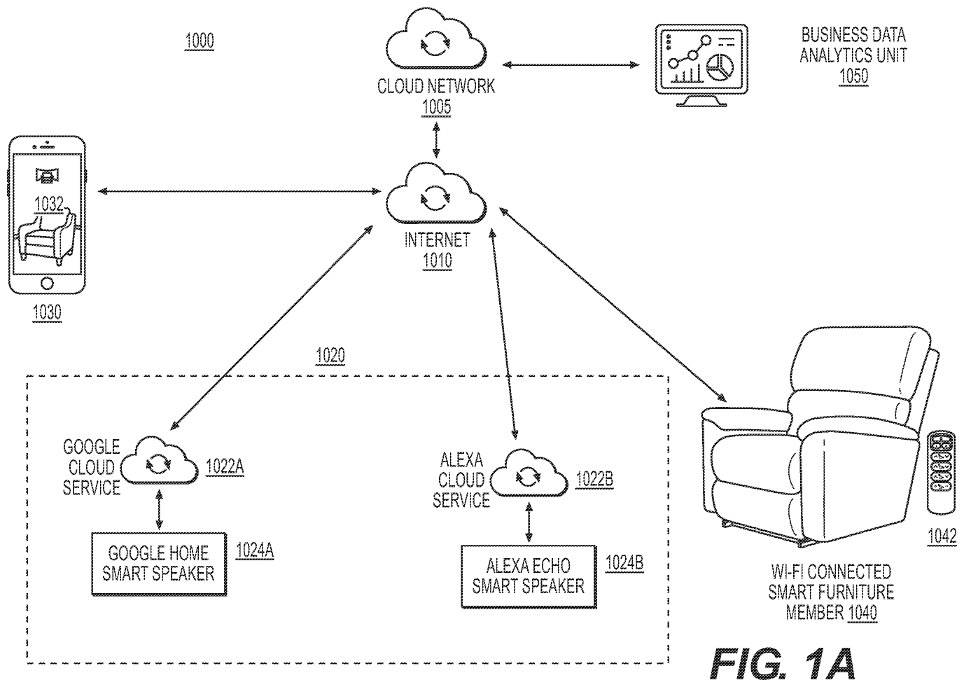

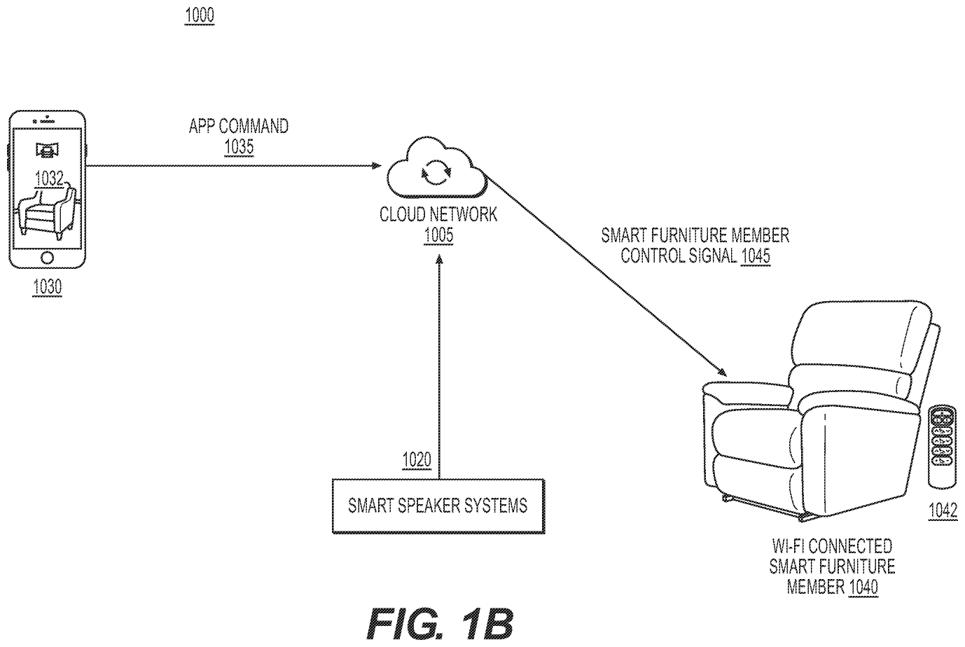

According to at least some example embodiments, a smart furniture internet of things (IoT) network facilitates a user's control of a furniture member (e.g., a chair, sofa, loveseat, etc.) via, for example, voice commands the user provides to a smart speaker device or app commands the user inputs into a smart furniture app of a user device (e.g., a mobile device). For example, the smart furniture IoT network provides an architecture through which smart furniture member control signals for controlling operations of a smart furniture member (e.g., movement of one or more movable parts of the smart furniture member) are generated based on the voice commands and/or app commands, and provided to the furniture member via the internet. Examples of the smart furniture IoT network will now be discussed in greater detail below with reference to FIGS. 1A and 1B.

FIG. 1A illustrates a portion of a smart furniture internet of things (IoT) network according to at least some example embodiments. FIG. 1B is an example for explaining the generation of smart furniture control signals in the smart furniture IoT network according to at least some example embodiments.

As is illustrated in FIG. 1A, a smart furniture IoT network 1000 includes a cloud network 1005 that is connected, via internet 1010, to smart speaker (or other virtual assistant) systems 1020, a user device 1030 and a smart furniture member 1040. The cloud network 1005 may also be connected to a business data analytics unit 1050.

The cloud network 1005 may include, for example, one or more servers including processors configured to perform operations described in the present specification as being performed by a cloud network (e.g., cloud network 1005). As is illustrated in FIG. 1B, according to at least some example embodiments, the cloud network 1005 may receive an app command 1035 from the user device 1030 and/or a voice command 1025 from the smart speaker systems 1020. Further, the cloud network 1005 may generate one or more smart furniture member control signals 1045 for controlling operations of the smart furniture member 1040 based on the received app commands 1035 and/or voice commands 1025. Further, the cloud network 1005 may send the generated smart furniture member control signals 1045 to the smart furniture member 1040, for example, through the internet 1010. As is illustrated in FIG. 1A, communications between the cloud network 1005 and each of the user device 1030, smart speaker systems 1020 and smart furniture member 1040 may take place via the internet 1010. The smart speaker systems 1020 will now be discussed in greater detail below.

As is illustrated in FIG. 1A, the smart speaker (or other virtual assistant) systems 1020 include a first smart speaker (or other virtual assistant) and a second smart speaker (or other virtual assistant) system. The first and second smart speaker systems include first and second smart speaker devices 1024A and 1024B connected to first and second smart speaker cloud services 1022A and 1022B, respectively. The first and second smart speaker cloud services 1022A and 1022B may each include, for example, one or more servers including processors configured to perform operations described in the present specification as being performed by a smart speaker cloud service. The first and second smart speaker cloud services 1022A and 1022B may be connected to the cloud network 1005 via the internet 1010. Further, though not illustrated for the purpose of clarity, the first and second smart speaker devices 1024A and 1024B may be connected to the first and second smart speaker cloud services 1022A and 1022B via the internet 1010.

The first and second smart speaker devices 1024A and 1024B may each include, among other elements, microphones for receiving audio signals, speakers for producing audio signals, and a processor for controlling operations of the smart speaker devices. In the example illustrated in FIG. 1A, the first smart speaker device 1024A is a Google Home smart speaker (e.g., a Google Nest Audio speaker), the first smart speaker cloud service 1022A includes one or more Google cloud services, the second smart speaker device 1024B is an Amazon Alexa smart speaker (e.g., an Echo Dot speaker), and the second smart speaker cloud service 1022B is includes one more Amazon Alexa cloud services (e.g., Alexa Voice Service).

According to at least some example embodiments, first and second smart speaker cloud services 1022A and 1022B provide support for operations of the smart speaker devices 1024A and 1024B, respectively. For example, the first and second smart speaker cloud services 1022A and 1022B may perform natural language processing to translate verbal audio signals (e.g., voice commands or queries spoken by a user of the smart furniture member 1040), which were received by a microphone of one of the smart speaker devices 1024A and 1024B and transmitted to one of the first and second smart speaker cloud services 1022A and 1022B, into text. According to at least some example embodiments, the voice command 1025 illustrated in FIG. 1B is generated, and sent to the cloud network 1005, by at least one of the first and second smart speaker cloud services 1022A and 1022B. According to at least some example embodiments, the voice command 1025 generated by at least one of the first and second smart speaker cloud services 1022A and 1022B includes the translated text which was translated from verbal audio signals (e.g., by performing natural language processing on verbal audio signals received from one of the smart speaker devices 1024A and 1024B) or instructions generated based on the translated text. The user device 1030 will now be discussed in greater detail below.

In the example illustrated in FIGS. 1 and 1B, the user device 1030 is a mobile phone running a smart furniture app 1032 that generates app commands 1035 for controlling the operations of the smart furniture member 1040, for example, based on input from a user of the user device 1030 into the user device 1030. Examples of devices which may embody the user device 1030 include, but are not limited to, a mobile device (e.g., a mobile phone, a tablet, a phablet, a laptop computer, a wearable device, etc.) an Internet of Things (IoT) device, and a desktop computer.

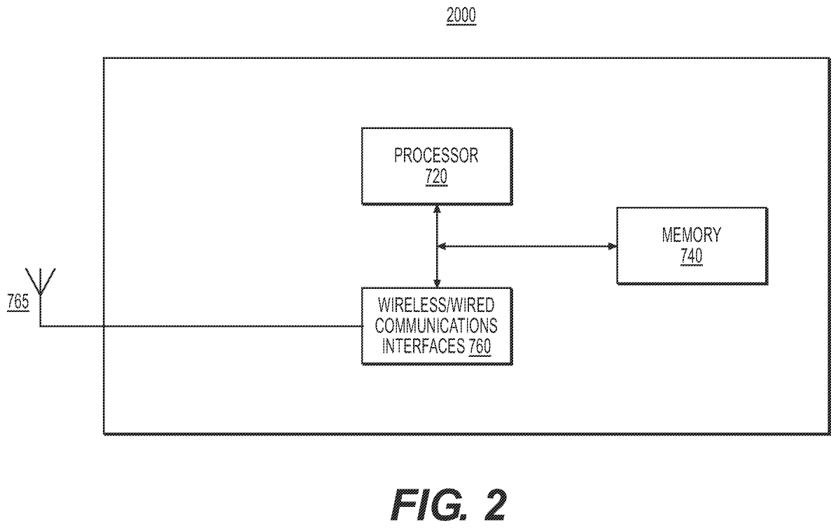

An example structure which may be used to embody one or more elements of the smart furniture IoT network 1000 (e.g., the user device 1030, one or more servers of the cloud network 1005, one or more servers of the first smart speaker cloud service 1022A, one or more servers of the second smart speaker cloud service 1022B, etc.) will now be discussed below with respect to FIG. 2.

FIG. 2 illustrates an example embodiment of a network device. Referring to FIG. 2, a network device 2000 includes: a memory 740, a processor 720, and various communications interfaces 760 connected to each other; and one or more antennas 765 connected to the various communications interfaces 760. The various interfaces 760 and the one or more antennas 765 may constitute a transceiver for transmitting/receiving data to/from other network devices of the smart furniture IoT network 1000, wirelessly. According to at least some example embodiments, in addition to, or alternatively, instead of, including interfaces for supporting wireless communications, various interfaces 760 may include interfaces for supporting wired communications.

As will be appreciated, depending on the implementation of the network device 2000, the network device 2000 may include many more components than those shown in FIG. 2 for providing the functionalities of the particular element of the smart furniture IoT network 1000 being embodied by the network device 2000 (e.g., functionalities of the user device 1030, a server of the cloud network 1005, a server of the first smart speaker cloud service 1022A, a server of the second smart speaker cloud service 1022B, etc.). However, it is not necessary that all of these generally conventional components be shown in order to disclose the illustrative example embodiment.

The memory 740 may be a computer readable storage medium that generally includes a random-access memory (RAM), read only memory (ROM), and/or a permanent mass storage device, such as a disk drive. The memory 740 may also store an operating system and any other routines/modules/applications for providing the functionalities of the particular element of the smart furniture IoT network 1000 being embodied by the network device 2000 (e.g., functionalities of a server of the cloud network 1005, a server of the first smart speaker cloud service 1022A, a server of the second smart speaker cloud service 1022B, the user device 1030, etc. in accordance with one or more example embodiments) to be executed by the processor 720. These software components may also be loaded from a separate computer readable storage medium into the memory 740 using a drive mechanism (not shown). Such separate computer readable storage medium may include a disc, tape, DVD/CD-ROM drive, memory card, or other like computer readable storage medium (not shown). In some example embodiments, software components may be loaded into the memory 740 via one of the various interfaces 760, rather than via a computer readable storage medium. According to at least some example embodiments, the memory 740 may store computer-executable instructions corresponding to any operations described as being performed by an element of the smart furniture IoT network 1000 (e.g., the cloud network 1005, the first smart speaker cloud service 1022A, the second smart speaker cloud service 1022B, the user device 1030, etc.).

The processor 720 may be configured to carry out instructions of a computer program by performing the arithmetical, logical, and input/output operations of the system. Instructions may be provided to the processor 720 by the memory 740.

The various interfaces 760 may include components that interface the processor 720 with the one or more antennas 765, or other input/output components. As will be understood, the various interfaces 760 and programs stored in the memory 740 to set forth the special purpose functionalities of the network device 2000 will vary depending on the particular element of the smart furniture IoT network 1000 being embodied by the network device 2000.

The various interfaces 760 may also include one or more user input devices (e.g., a keyboard, a keypad, a mouse, or the like) and user output devices (e.g., a display, a speaker, or the like). The smart furniture member 1040 will now be discussed in greater detail below.

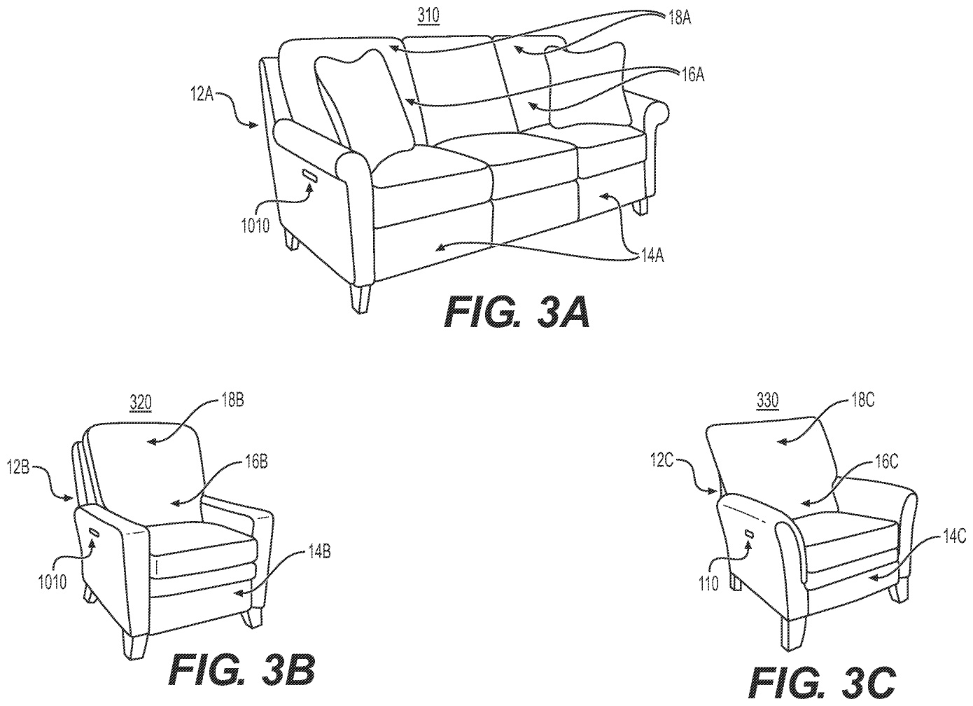

FIGS. 3A-3C illustrate various examples of the smart furniture member 1040 of FIGS. 1A and 1B according to at least some example embodiments. FIG. 3A illustrates a first furniture member 310, FIG. 3B illustrates a second furniture member 320 and FIG. 3C illustrates a third furniture member 330. In the examples illustrated in FIGS. 3A-3C, the first furniture member 310 is a sofa or couch, and the second and third furniture members 320 and 330 are chairs. The first through third furniture members 310-330 may each include movable parts. For example, as is illustrated in FIGS. 3A-3C, first through third furniture members 310-330 include frames 12A, 12B and 12C. According to at least some example embodiments, frames 12A, 12B and 12C may be frames that move or stationary frames. First through third furniture members 310-330 further include one or more movable legrest platforms 14A, 14B and 14C, one or more movable lumbar platforms 16A, 16B and 16C, and one or more movable headrest platforms 18A, 18B and 18C that are supported by the frames 12A, 12B and 12C and movable relative to the frames 12A, 12B and 12C. According to at least some example embodiments, additional movable parts that may be included in the first through third furniture members 310-330 include, but are not limited to, seatbacks, seat bottoms, seat cushions and armrests. For example, the first through third furniture members 310-330 may include a movable back recline mechanism. First through third furniture members 310-330 of FIGS. 3A-3C are provided as examples of smart furniture member 1040. However, smart furniture member 1040 is not limited to the examples provided in FIGS. 3A-3C and may embodied by other types of furniture.

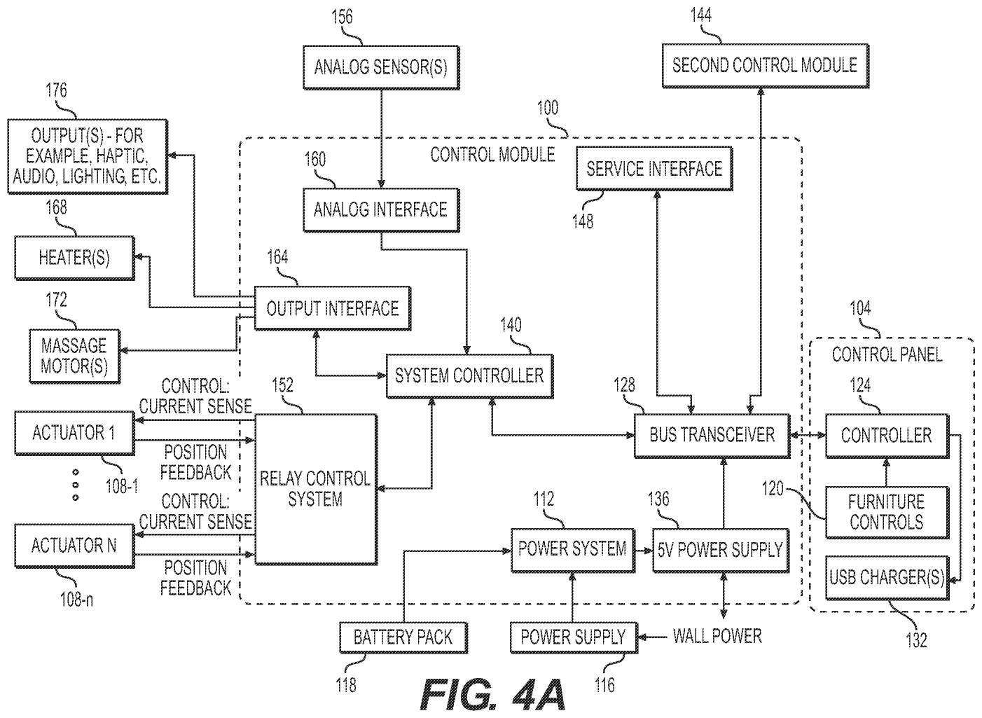

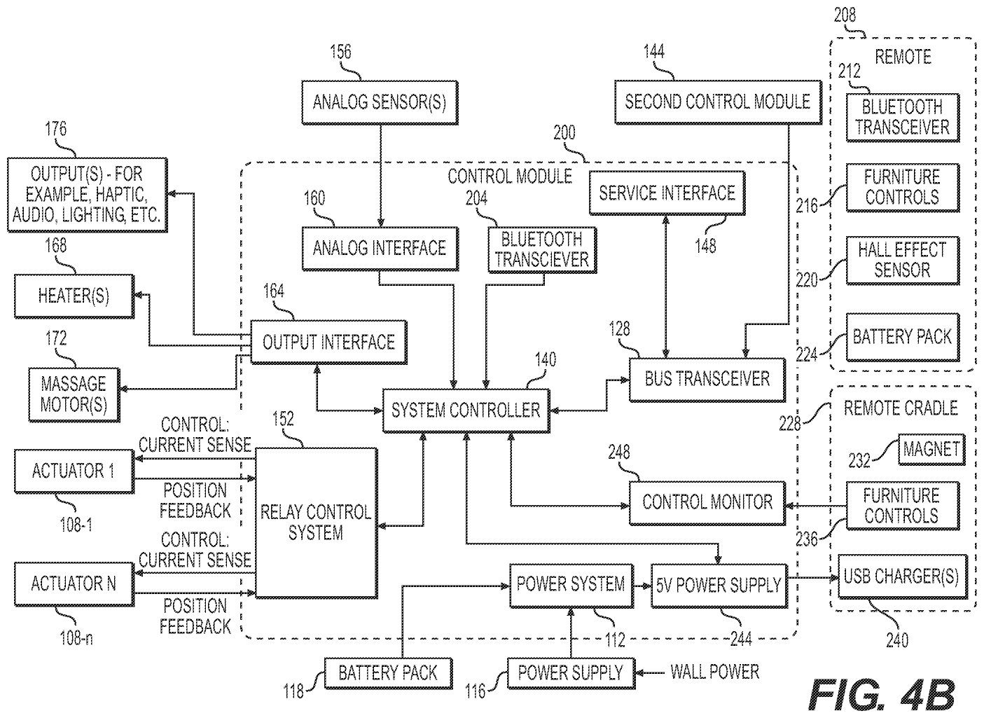

FIG. 4A shows a first control module 100, also known as a furniture control module, a master control module (MCM), or control circuitry. The first control module 100 receives user input, such as via a control panel 104, and controls one or more actuators 108-1, . . . 108-N (referred to collectively as actuators 108).

The first control module 100 includes a power system 112 that receives wall power (also known as grid power, utility power, or mains electricity). For example, a power supply 116 (which may be external as shown in FIG. 4A) may receive wall power and condition or convert the power. For example, the power supply 116 may transform the wall power to a lower voltage alternating current or may convert the wall power into a direct current power supply. As examples only, the wall power may be 230 Volt 50 Hz alternating current power or 120 Volt 60 Hz alternating current.

The power system 112 may also be configured to receive power from a battery pack 118. The battery pack 118 may be a rechargeable battery pack, in which case the power system 112 may be able to recharge the battery pack 118 based on power from the power supply 116. In other implementations, the battery pack 118 may include non-rechargeable batteries, such as 9V alkaline batteries. In various implementations, both rechargeable and non-rechargeable battery packs may be provided and connected to the power system 112.

The control panel 104 includes furniture controls 120, which may be one or more touch- or pressure-activated inputs. For example, the furniture controls 120 may include pushbuttons, rocker switches, touch-sensitive buttons, a touchscreen, etc. As shown in FIG. 4A, the control panel 104 includes a controller 124 that reads input from the furniture controls 120 and transmits that input to the first control module 100 via a bus transceiver 128 of the first control module 100.

For example, the controller 124 may send a bus message to the bus transceiver 128 in response to a momentary press of a button of the furniture controls 120. In response to a press and hold of one of the buttons of the furniture controls 120, the controller 124 may send a button press message to the bus transceiver 128 followed eventually by a button release message. In the interim, the controller 124 may continue to send “button remains pressed” messages to the bus transceiver 128.

For the user's convenience, the control panel 104 may include one or more universal serial bus (USB) chargers 132. Although shown within the outline of the control panel 104, one or more of USB chargers 132 may be located separately from the control panel 104. For example, for user convenience, the USB chargers 132 may be distributed between left and right sides of a piece of furniture. To power the USB chargers 132, an appropriate voltage source, such as a 5V power supply 136 provides power to the control panel 104. For example, the 5V power supply 136 may power the bus transceiver 128 which provides power to the control panel 104.

A system controller 140 of the first control module 100 receives information about user inputs via the bus transceiver 128. The system controller 140 may also control whether the USB chargers 132 are active. In response to a command to deactivate the USB chargers 132, the controller 124 may cut off power flowing to some or all of the USB chargers 132.

In furniture where there are multiple sets of actuators, such as in a sofa with multiple reclining seating positions, the system controller 140 may coordinate with corresponding control modules. In FIG. 4A, a second control module 144 is shown for illustration. A service interface 148 connected to the bus transceiver 128 may permit assemblers at a manufacturing facility or technicians at a repair facility to obtain diagnostic information, perform calibration, and troubleshoot issues. In various implementations, the bus transceiver 128 may use a variation of the local interconnects network (LIN) bus.

The first control module 100 controls the actuators 108 using a relay control system 152. When controlling the actuator 108-1, the relay control system 152 may sense the amount of current being supplied to the actuator 108-1. In addition, the relay control system 152 may receive positioning feedback from the actuator 108-1. For example, the position feedback may include counts from an encoder, which may be detected using a Hall Effect sensor. As described in more detail below, this position feedback may not be completely reliable if the actuator has recently stopped moving or was in fact still moving when power was removed from the first control module 100.

The system controller 140 may receive input from other sources, such as one or more analog sensors 156. The analog sensors 156 may include an occupancy sensor. An analog interface 160 receives and transforms, such as by converting into digital signals, information from the analog sensors 156 for provision to the system controller 140.

The first control module 100 may also generate additional outputs beyond controlling the actuators 108. For example, an output interface 164 of the first control module 100 may control one or more heaters 168, one or more massage motors 172, and one or more user outputs 176. For example, the user outputs 176 may include one or more of haptic feedback actuators, audio outputs, lighting, etc. In various implementations, the output interface 164 may output pulse-width modulation (PWM) signals.

In FIG. 4B, a wireless remote variant of a controller architecture includes a second control module 200. The second control module 200 includes a first Bluetooth transceiver 204 that wirelessly communicates with a remote 208. The remote 208 includes a Bluetooth transceiver 212, furniture controls 216, a Hall Effect sensor 220, and a battery pack 224. The furniture controls 216 may be the same as or a rearranged version of the furniture controls 120 of FIG. 4A.

The remote 208 may be stored in a remote cradle 228 when not in use. Although not shown, the remote cradle 228 may charge the battery pack 224 of the remote 208 while located in the remote cradle 228. The remote cradle 228 may include a magnet 232, which may be detected by the Hall Effect sensor 220 of the remote 208 to indicate to the remote 208 that it is located in the remote cradle 228.

The remote cradle 228 may include furniture controls 236, which may be a superset or a subset of the furniture controls 216. In various implementations, the furniture controls 236 may include an input indicating the user's desire to return the furniture to a home position and/or to one or more memory positions. In addition, the furniture controls 236 may also include controls for pairing the remote 208 to the second control module 200.

In various implementations, the remote cradle 228 may also include one or more USB chargers 240. As described above with respect to FIG. 4A, the USB chargers 240 may not all be co-located in the remote cradle 228. The USB chargers 240 may receive power from a 5V power supply 244. The 5V power supply 244 may be the same as the 5V power supply 136 of FIG. 4A. The 5V power supply 244 may be controllable by the system controller 140 to interrupt power to the USB chargers 240 in order to deactivate the USB chargers 240. For example, the USB chargers 240 may be deactivated when operating from battery power rather than wall power.

The same reference numeral is used for the system controller 140 although separate system controllers may be used for the first control module 100 compared to the second control module 200. In the examples shown in FIG. 4A and FIG. 4B, the system controller 140 is shown with the same reference numeral to indicate that common software and hardware may be used for the system controller 140 though the software may operate differently depending on whether the system controller 140 is present in the first control module 100 or the second control module 200. The second control module 200 may include a control monitor 248, which scans the furniture controls 236. For example, the control monitor 248 may monitor the resistance through each of the furniture controls 236 to detect whether a button is being pressed. The control monitor 248 then supplies this information to the system controller 140.

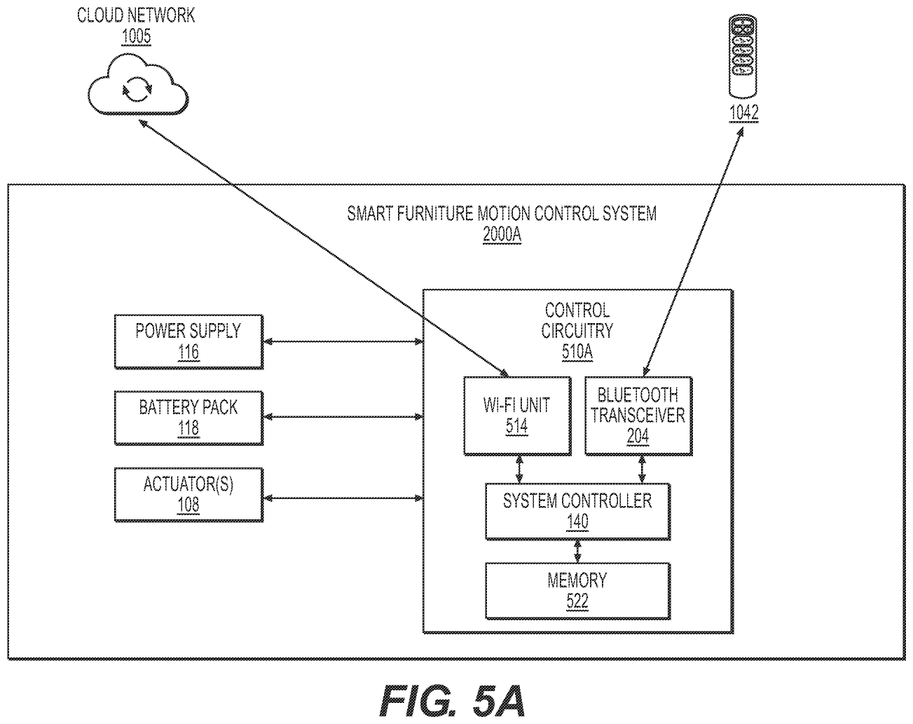

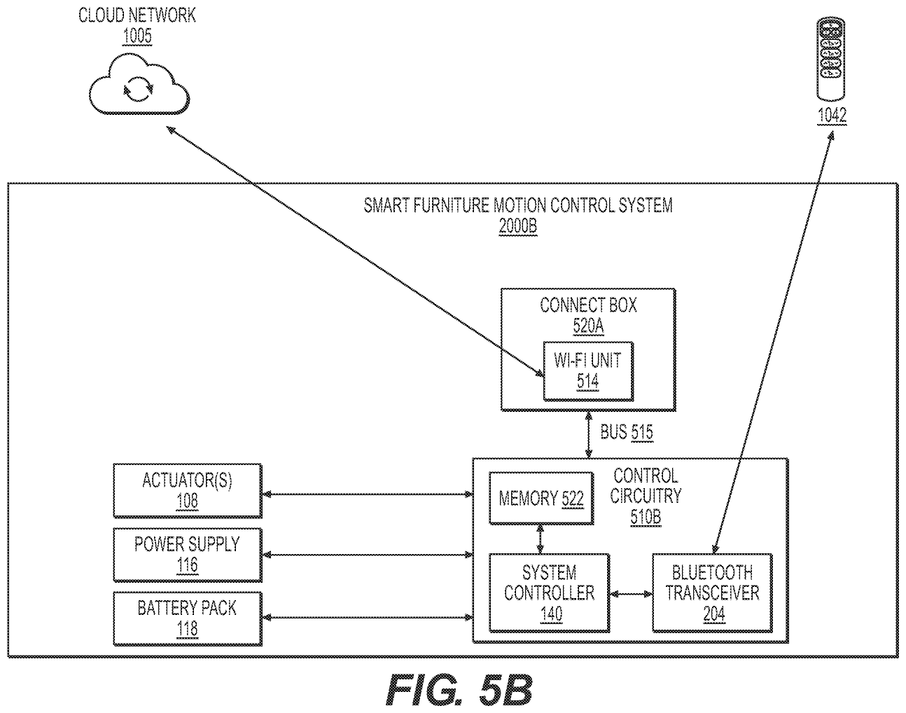

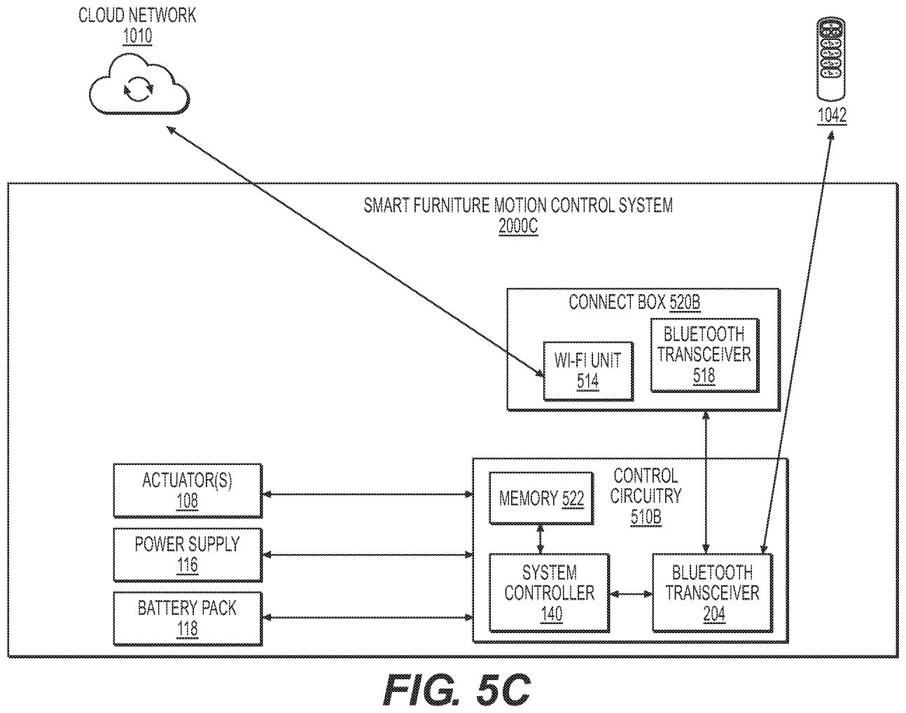

The smart furniture member 1040 may include a smart furniture motion control system. FIGS. 5A-5C illustrate examples of smart furniture motion control systems which may be included in the smart furniture member 1040 of FIGS. 1A and 1B.

Referring to FIG. 5A, a first smart furniture motion control system 2000A may include first control circuitry 510A, a power supply 116, a battery pack 118, and one or more actuators 108. According to at least some example embodiments, the power supply 116 and/or a battery pack 118 are electrically connected to, and provide power to, the one or more actuators 108 and the first control circuitry 510A. According to at least some example embodiments, power is provided from the power supply 116 and/or a battery pack 118 to the actuators 108 via the first control circuitry 510A. For example, the power supply 116 and/or battery pack 118 may be electrically connected to, and provide power to the first control circuitry 510A, the first control circuitry 510A may be electrically connected to the one or more actuators 108, and the first control circuitry 510A may handle distributing power to the one or more actuators 108.

Referring to FIG. 5A, the first control circuitry 510A of the first smart furniture motion control system 2000A controls the operation (e.g., driving) the one or more actuators 108. Further, the actuators 108 control the motion of one or more movable parts of the smart furniture member 1040. For example, in an example scenario in which the smart furniture member is embodied by the first furniture member 310 of FIG. 3A, in accordance with known methods and structures for driving the movement of movable parts of a furniture member with an electric motor, based on the direction in which one or more of the actuators 108 are driven (e.g., forwards or backwards), the actuators 108 may cause one or more parts of the first furniture member 310 to move. Examples of such movement of parts of the first furniture member 310 include, but are not limited to, extension and retraction of one or more of the movable legrest platforms 14A, one or more of the movable lumbar platforms 16A, and/or one or more of the movable headrest platforms 18A of the first furniture member 310, and tilting (e.g., in a forward or backward direction) or reclining of one or more seatbacks and/or seatback cushions of the first furniture member 310. According to at least some example embodiments, movement of the seatback (and/or seatback cushions), the one or more legrest platforms 14A, the movable lumbar platforms 16A, and the one or more of the movable headrest platforms 18A and the back recline mechanism are individually controlled.

According to at least some example embodiments, the first control circuitry 510A is an example of the second control module 200 of FIG. 4B to which a Wi-Fi unit 514 has been added. For example, the first control circuitry 510A includes the system controller 140, and the system controller 140 is connected to the Wi-Fi unit 514, the first Bluetooth transceiver 204 and a memory 522. The Wi-Fi unit 514 may be or include a Wi-Fi transceiver that includes one or more antennas and circuitry for performing transmission and/or reception of data and/or instructions via wireless signals, for example, in accordance with one or more of the Institute of Electrical and Electronics Engineers (IEEE) 802.11 standards. The Wi-Fi unit 514 may also be referred to as the W-Fi transceiver 514. The first Bluetooth transceiver 204 may include one or more antennas and circuitry for performing transmission and/or reception of data and/or instructions via wireless signals, for example, in accordance with one or more of the Bluetooth standards (e.g., the Bluetooth Special Interest group (SIG) standards). For example, as is illustrated in FIG. 5A, the Wi-Fi unit 514 allows the first smart furniture motion control system 2000A to communicate with the cloud network 1005 (e.g., via the internet 1010) using wireless signals in accordance with Wi-Fi technology. Further, as is illustrated in FIG. 5A, the first Bluetooth transceiver 204 allows the first smart furniture motion control system 2000A to communicate with a remote 1042 using wireless signals in accordance with Bluetooth technology. According to at least some example embodiments, the remote 1042 may be used to control various operations of the smart furniture member. Elements of the first control circuitry 510A (e.g., the Wi-Fi unit 514 and first Bluetooth transceiver 204) may each be embodied by a circuit or circuitry. Accordingly, the Wi-Fi unit 514 and first Bluetooth transceiver 204 may also be referred to in the present specification, respectively, as the Wi-Fi circuit 514 and a first Bluetooth circuit 204. Further, though, in the example illustrated in FIG. 5A, the Wi-Fi unit 514 and the first Bluetooth transceiver 204 are illustrated as being separate from the system controller 140, according to at least some example embodiments, the functionality of the Wi-Fi unit 514 and the first Bluetooth transceiver 204 may be embodied by the system controller 140 (i.e., the system controller 140 may be structured to perform the functions described in the present specification as being performed by the Wi-Fi unit 514 and/or the first Bluetooth transceiver 204).

According to at least some example embodiments, the system controller 140 controls elements of the first control circuitry 510A (e.g., the Wi-Fi unit 514 and first Bluetooth transceiver 204) generally. According to at least one example embodiment of the inventive concepts, the system controller 140 may include or be implemented by one or more circuits or circuitry (e.g., hardware) specifically structured to carry out and/or control some or all of the operations described in the present specification as being performed by the system controller 140, the first control circuitry 510A, or an element thereof. According to at least one example embodiment of the inventive concepts, the system controller 140 may include or be implemented by a memory and one or more processors executing computer-readable code (e.g., software and/or firmware) that is stored in the memory and includes instructions for causing the one or more processors to carry out and/or control some or all of the operations described in the present specification as being performed by the system controller 140, control circuitry (e.g., first control circuitry 510A), or an element thereof. According to at least one example embodiment of the inventive concepts, the system controller 140 may be implemented by, for example, a combination of the above-referenced hardware and one or more processors executing computer-readable code. The term ‘processor’, as used in the present disclosure, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a microcontroller, a central processing unit (CPU), a processor core, a multi-core processor; a multiprocessor, an application-specific integrated circuit (ASIC), and a field programmable gate array (FPGA). Processors executing program code are programmed processors, and thus, are special-purpose computers.

FIG. 5B illustrates a second smart furniture motion control system 2000B. The second smart furniture motion control system 2000B may have the same structure and operation as the first smart furniture motion control system 2000A, with the exception that, instead of the first control circuitry 510A, the second smart furniture motion control system 2000B includes second control circuitry 510B and a first connect box 520A connected to the second control circuitry 510B via a bus 515. Accordingly, discussions of like elements may be omitted. According to at least some example embodiments, the power supply 116 and/or a battery pack 118 are electrically connected to, and provide power to, the one or more actuators 108, the second control circuitry 510B, and the first connect box 520A. According to at least some example embodiments, power is provided from the power supply 116 and/or a battery pack 118 to the actuators 108 and/or first connect box 420 via the second control circuitry 510B. For example, the power supply 116 and/or battery pack 118 may be electrically connected to, and provide power to the second control circuitry 510B, the second control circuitry 510B may be electrically connected to the one or more actuators 108 and electrically connected to the first connect box 520A (e.g., via bus 515), and the second control circuitry 510B may handle distributing power to the one or more actuators 108 and the first connect box 520A.

According to at least some example embodiments, the second control circuitry 510B is an example of the second control module 200 of FIG. 4B. For example, the first control circuitry 510A includes the system controller 140, and the system controller 140 is connected to the first Bluetooth transceiver 204 and a memory 522. In comparison with the first control circuitry 510A, the second control circuitry 510B does not include the Wi-Fi unit 514. Instead, the Wi-Fi unit 514 is included in the first connect box 520A which is separate from the second control circuitry 510B. Thus, data and/or instructions that are received through wireless signals at the Wi-Fi unit 514 may be transmitted from the first connect box 520A to the second control circuitry 510B via the bus 515, and data and/or instructions received by the first connect box 520A from the second control circuitry 510B via the bus 515 may be transmitted from the first connect box 520A as wireless signals by the Wi-Fi unit 514. Accordingly, the first connect box 520A provides Wi-Fi functionality in a modular form. For example, with respect to an existing furniture member which includes control circuitry that lacks Wi-Fi functionality (e.g., second control circuitry 510B), control circuitry can be added to the existing furniture member, without the need to replace the entire control circuitry of the existing furniture member (e.g., replacing second control circuitry 510B with Wi-Fi-capable first control circuitry 510A), by adding the first connect box 520A which includes the Wi-Fi unit 514. Accordingly, furniture members lacking Wi-Fi functionality may be upgraded to include Wi-Fi functionality in a relatively simple manner.

FIG. 5C illustrates a third smart furniture motion control system 2000C. The third smart furniture motion control system 2000C may have the same structure and operation as the second smart furniture motion control system 2000B, with the exception that, instead of the first connect box 520A being connected to the second control circuitry 510B via a bus 515, a second connect box 520B that includes Bluetooth functionality is connected to the second control circuitry 510B, wirelessly, via a Bluetooth connection. Accordingly, discussions of like elements may be omitted. According to at least some example embodiments, the power supply 116 and/or battery pack 118 are electrically connected to, and provide power to, the one or more actuators 108 and the second control circuitry 510B. According to at least some example embodiments, power is provided from the power supply 116 and/or a battery pack 118 to the actuators 108 via the second control circuitry 510B. For example, the power supply 116 and/or battery pack 118 may provide power to the second control circuitry 510B, the second control circuitry 510B may be electrically connected to the one or more actuators 108, and the second control circuitry 510B may handle distributing power to the one or more actuators 108. According to at least some example embodiments, the second connect box 520B includes an external connection for connecting to an external power source (e.g., universal serial bus (USB) port for connecting to an external power source via a USB cable).

In comparison with the first connect box 520A, the second connect box 520B may additionally include a second Bluetooth transceiver 518. The second Bluetooth transceiver 518 may include one or more antennas and circuitry for performing transmission and/or reception of data and/or instructions via wireless signals, for example, in accordance with one or more of the Bluetooth standards (e.g., the Bluetooth SIG standards). Thus, the data and/or instructions described above with reference to FIG. 5B as being transmitted between the first connect box 520A and the second control circuitry 510B via the bus 515 may, instead, be transmitted between the second connect box 520B and the second control circuitry 510B via a wireless Bluetooth connection between the first and second Bluetooth transceivers 204 and 518 in the third smart furniture motion control system 2000C of FIG. 5C. Elements of the second connect box 520B (e.g., the Wi-Fi unit 514 and the second Bluetooth transceiver 518) may each be embodied by a circuit or circuitry. Accordingly, the Wi-Fi unit 514 and a second Bluetooth transceiver 518 may also be referred to in the present specification, respectively, as the Wi-Fi circuit 514 and a second Bluetooth circuit 518. Thus, similar to the first connect box 520A of the second smart furniture motion control system 2000B of FIG. 5B, the second connect box 520B of the third smart furniture motion control system 2000C of FIG. 5C also provides Wi-Fi functionality in a modular form. Further, according to at least some example embodiments, the second connect box 520B may be used with more flexibility than the first connect box 520A since a physical (i.e., wired) connection between the second connect box 520B and the second control circuitry 510B is not necessary. Example voice control scenarios will now be discussed below.

### Example Voice Control Scenarios

According to at least some example embodiments, a user may issue a voice command to cause the smart furniture member 1040 to perform a specified operation (e.g., moving a specific part of the smart furniture member 1040 to a specific position). For example, the user may issue a voice command 1025 that, as an example of a desired operation, specifies a desired movable part of the smart furniture member 1040 and a desired position in order to cause the smart furniture member 1040 to move the specified part to the specified position. Specifically, as is discussed above with reference to FIGS. 1A and 1B, the voice command 1025 issued by the user will be received as an audio signal by the microphone of a smart speaker device (e.g., first smart speaker device 1024A); the smart speaker device will send the voice command 1025 (e.g., in the form of the received audio signal) to a smart speaker cloud service (e.g., the first smart speaker cloud service 1022A); the smart speaker cloud service may generate translated text from the audio signal of the voice command 1025 (e.g., by performing natural language processing to translate the audio signal into text) and send the voice command 1025 to the cloud network 1005 (e.g., in the form of the translated text or a command generated based on the translated text); and the cloud network 1005 may generate one or more smart furniture member control signals 1045 for controlling the smart furniture member 1040 to move the movable part specified by the voice command 1025 to the position specified by the voice command 1025. Examples of different types of voice commands will now be discussed in greater detail below.

### Individual Motions

For example, according to at least some example embodiments, a smart furniture motion control system (e.g., 2000A, 2000B or 2000C) of the smart furniture member 1040 may implement a memory function by which the smart furniture motion control system stores a current position of one or more movable parts of the smart furniture member 1040 (e.g., in memory 522 of the first or second control circuitry 510A or 510B). When such a memory function is implemented, the smart furniture motion control system (e.g., 2000A, 2000B or 2000C) is capable of moving the movable parts of the smart furniture member 1040 to a plurality of specific positions. For example, a user can say “set legrest to 75%” in order to extend a legrest of the smart furniture member 1040 to 75% of a maximum legrest extension position. As another example, a user can say “move headrest halfway” in order to extend a headrest of the smart furniture member 1040 to 50% of a maximum headrest position.”

According to at least some example embodiments, when the smart furniture motion control system (e.g. 2000A, 2000B or 2000C) of the smart furniture member 1040 does not implement a memory function by which the smart furniture motion control system stores a current position of one or more movable parts of the smart furniture member 1040, the smart furniture motion control system (e.g. 2000A, 2000B or 2000C) may be capable of moving the movable parts of the smart furniture member 1040 to a limited number of specific positions (e.g., a fully extended position or a closed/non-extended position). In this case, a user can say, for example, “fully extend the legrest” or “close the legrest” in order to extend a legrest of the smart furniture member 1040 to a maximum legrest extension position or to retract the legrest of the smart furniture member 1040 to a closed position.

### Storing Positions as Presets

As yet another example, a user may cause the smart furniture member 1040 to store a current position of a movable part of the smart furniture member 1040 (or, alternatively, multiple current positions of multiple movable parts of the smart furniture member 1040, respectively) as a preset, which the user can recall later by specifying the stored preset. For example, a user may say “save this position to memory 2” in order to save one or more current positions of one or more movable parts of the smart furniture member 1040 as a preset named “memory 2.” According to at least some example embodiments, the smart furniture member 1040 may store the one or more positions in memory (e.g., in memory 522 of the first or second control circuitry 510A or 510B) included in a smart furniture motion control system (e.g., 2000A, 2000B or 2000C) of the smart furniture member 1040. Further, later, the user may recall the previously sored preset, for example, by saying “go to memory 2 setting” in order cause the one or more movable parts of the smart furniture member 1040 to move to the one or more positions previously saved in accordance with the preset named “memory 2.”

### Stop Motion

According to at least some example embodiments, a user may issue a verbal command for causing all current motion of the smart furniture member 1040 to stop. For example, the user may say “stop the recliner,” for example, in a case where the smart furniture member 1040 is a recliner, in order cause any currently moving movable parts of the smart furniture member 1040 to stop moving. For example, control circuitry (e.g., 510A or 510B) of the smart furniture member 1040 may control any or all of the one or more actuators 108 such that movement of one or more movable parts of the smart furniture member 1040 ceases.

### Finding the Remote

According to at least some example embodiments, a user may issue a verbal command for causing the smart furniture member 1040 to control the remote 1042 to indicate its current position to the user (e.g., by making an audible sound and/or visible flashing light pattern). For example, the user may say “find the remote” in order cause the smart furniture member 1040 to send a wireless signal to the remote 1042 (e.g., via first Bluetooth transceiver 204 of the first or second control circuitry 510A or 510B) for causing the remote 1042 to generate an audible noise and/or flashing light pattern.

### Heat and Massage Functions

According to at least some example embodiments, the smart furniture member 1040 may include a heating function and/or a massage function and a user may issue a verbal command for causing the smart furniture member 1040 to initiate the heating function and/or massage function. For example, the furniture member may include a heater (e.g., a heating pad) for performing the heating function and/or a massager for performing the massage function. For example, a user may say “turn on the heating pad” to cause the smart furniture member 1040 to begin the heating function or “turn the massage on” to cause the smart furniture member 1040 to begin the massage function. Further, according to at least some example embodiments, in addition to specifying a desired function (e.g., heating or massaging) in the verbal command, the user can also specify setting for the desired function (e.g., a desired level or strength of the heating function or massage function and/or a desired massage pattern of the massage function). For example, a user may say “turn on the heating pad low” to cause the smart furniture member 1040 to initiate the heating function and set the heating function to a low level. As another example, a user may say “turn on the massage on high” to cause the smart furniture member 1040 to initiate the massage function and set the massage function to a high level.

Further, according to at least some example embodiments, the smart speaker (e.g., first smart speaker device 1024A) may ask the user to specify settings of the massage or heating function and set the massage or heating function based on a setting verbally specified by the user in response to question asked by the smart speaker.

### Query Functions

According to at least some example embodiments, a user may issue a verbal query to the smart furniture member 1040 or smart speaker device 1024A, 1024B to request an audible report of a status of one or more components of the smart furniture member 1040. For example, the user may issue a verbal query asking for the battery level (i.e., battery's state of charge) of the smart furniture member 1040, and in response, the smart speaker may reply with an audible report of the current battery level (e.g., a percentage of remaining battery charge) of the smart furniture member 1040. As another example, the user could issue a verbal query asking what is the current position of the backrest, legrest, lumbar, or headrest mechanisms, for example, and the smart speaker may reply with an audible report of the current position of such mechanism(s) (e.g., the backrest is reclined 40% or the legrest is extended 90%, for example).

The particular phrases quoted above are only examples of voice commands. Those skilled in the art will understand that the same, or similar, commands may be issued by using combinations of words that differ from the examples provided above.

### Example Connect Box Structure

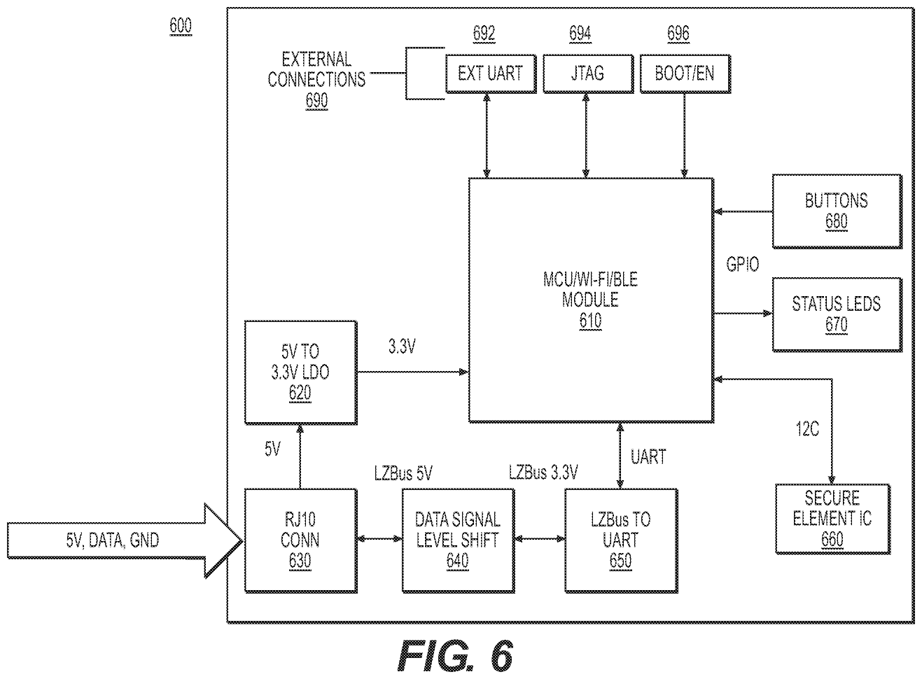

FIG. 6 illustrates a block diagram of an example of a connect box 600. According to at least some example embodiments, one or both of the first connect box 520A of FIG. 5B and the second connect box 520B of FIG. 5C may have the structure of the connect box 600 on FIG. 6.

Referring to FIG. 6, the connect box may include a controller 610 that controls the overall operation of the connect box 600. According to at least some example embodiments, the controller 610 may include circuitry supporting the operations of a Wi-Fi transceiver and/or a Bluetooth transceiver. For example, according to at least some example embodiments, the controller 610 may include a Wi-Fi transceiver (e.g., Wi-Fi transceiver 514 of FIGS. 5A-5C). Further, according to at least some example embodiments, the controller 610 may include a Wi-Fi transceiver and the second Bluetooth transceiver (e.g., second Bluetooth transceiver 518 of FIG. 5C). For example, the controller 610 may be a MCU/Wi-Fi/BLE module.

According to at least some example embodiments, the controller 610 may be or include an Espressif ESP32-WROOM module. As is illustrated in FIG. 6, the controller 610 is connected to external connections 690. External connections 690 may include an external universal asynchronous receiver/transmitter (UART) connection 692 which may be used, for example, for serial communication & bootloader-based programming with a personal computer (PC); a Joint Test Action Group (JTAG) connection 694 which may be used, for example, for software debugging and direct memory manipulation/programming; and a boot/enable connection 696 which may be used, for example, for connecting to boot and enable pins of the controller 610.

The connect box 600 may further include voltage converter circuit 620, an input connector circuit 630, a data level shifter circuit 640, and a data converter circuit 650, and a secure element integrated circuit (IC) 660. According to at least some example embodiments, the voltage converter circuit 620 may convert a 5V voltage to 3.3V for use by the controller 610. The input connector circuit 630 may bring a 5V voltage, a ground (GND) voltage, and bus data (e.g., data of the bus 515 of FIG. 5B) to a Wi-Fi board (e.g., a board including circuitry of a Wi-Fi transceiver in the controller 610). The data level shifter circuit 640 may convert bus data (e.g., data of the bus 515 of FIG. 5B) from a first level (e.g., a 5V logic level) to a second level (e.g., a 3.3V logic level). The data converter circuit 650 may convert bus data (e.g., data of the bus 515 of FIG. 5B) from a single line into separate UART Rx & Tx lines that are to be provided to the controller 610. The secure element IC 660 may facilitate secure data connections to external entities. For example, the secure element IC 660 may facilitate a transport layer security (TLS) connection between the connect box 600 and the Amazon Web Services (AWS) internet of things (IoT) core. For example, the secure element IC 660 may allow for secure connections between elements including the connect box 600 (e.g., the second smart furniture motion control system 2000B and/or the third smart furniture motion control system 2000C) and external entities such as the Amazon Web Services (AWS) internet of things (IoT) core. According to at least some example embodiments, the secure element IC 660 may be or include the Microchip technology ATECC608B.

As is also illustrated in FIG. 6, the controller 610 may be connected to various buttons 680 and status light emitting diodes (LEDs) 670.

### Example Smart Furniture App

According to at least some example embodiments, a user may access an app (e.g., an app that operates on a smartphone, tablet, or other mobile device) for the smart furniture member and/or for the smart speaker device. The user may access the app to control the functionality of the smart furniture member 1040 described above. For example, the user may tap or click buttons in the app to issue one or more app commands 1035 from the user device 1030 to cause movement of various components of the smart furniture member 1040 (e.g., one or more of the backrest, legrest, headrest, and lumbar mechanisms). Such buttons in the app may be associated with one or more built-in or user-customized preset or memory positions. The app may also include sliders (or buttons, text fields, or other user controls) for setting the positions of one or more components of the furniture member (one or more of the backrest, legrest, headrest, and lumbar mechanisms). The app sliders could be configured to allow the user to select a percentage along the component's range of motion (for example, 40% backrest recline, 90% legrest extension, etc.). The app may also be configured to allow the user to manage (e.g., add, delete, and/or edit) preset or memory positions.

The app may also be configured to provide a visual indication of the battery status of the furniture member. The app may also be configured to provide a visual indication of the furniture member's WiFi connectivity status and/or the Bluetooth connectivity status. The app may also a button or other control to issue an app command to assist the user in locating the remote 1042 (e.g., by causing the remote 1042 to emit an audible chime or tone). The app may also be configured to provide a visual indication of a connectivity status of the remote 1042 (e.g., a Bluetooth or WiFi) connectivity status). The app may also be configured to provide a visual indication of a power status of the furniture member (i.e., whether the furniture member is connected to a power source).

In some example embodiments, the furniture member 1040 may include a lockout button or switch that allows the user to initiate a lockout (or do-not-disturb) feature that disables the voice commands and/or app commands (i.e., to prevent the furniture member from moving in response to voice commands and/or app commands). The app may include a graphical indicator that informs the user when the lockout button or switch has been set to engage the lockout feature.

The app may also include user interfaces that allow the user to set one or more routines to move or actuate one or more components of the furniture member (e.g., move or actuate one or more of the backrest, legrest, headrest, lumbar, and/or massaging mechanisms) in response to satisfaction of one or more user-defined conditions (e.g., issuance of a voice command by the user, at certain days of the week and time(s) of day, and/or based on geolocation of a user, for example).

### Controlling Multiple Smart Furniture Members

According to at least some example embodiments, a user may issue a voice command or app command to control components of multiple smart furniture members connected to the smart speaker system 1020. For example, the user may issue a single voice command to cause all of the smart furniture members to move into a home preset or memory position. Additionally or alternatively, the user may issue a voice command that moves one or more components of a specific one of the multiple furniture members.

### General

The wireless communications described in the present disclosure can be conducted in full or partial compliance with IEEE standard 802.11-2016, IEEE standard 802.16-2009, IEEE standard 802.20-2008, and/or Bluetooth Core Specification v4.0. In various implementations, Bluetooth Core Specification v4.0 may be modified by one or more of Bluetooth Core Specification Addendums 2, 3, or 4. In various implementations, IEEE 802.11-2016 may be supplemented by draft IEEE standard 802.11ah-2016 and/or draft IEEE standard 802.11ai-2016.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

In this application, including the definitions below, the term “module” or the term “controller” may be replaced with the term “circuit.” The term “module,” “controller,” “control circuitry,” or “control system” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A smart furniture motion control system for controlling movement of one or more movable parts of a first furniture member, the system comprising:
one or more actuators configured to control movement of the one or more movable parts of the first furniture member;
a Wi-Fi circuit configured to send and receive wireless signals; and
control circuitry configured to control the one or more actuators,
wherein the control circuitry is configured to, in response to receiving a smart furniture control signal from a cloud network via the Wi-Fi circuit, drive the one or more actuators such that the one or more movable parts move in accordance with one or more operations specified by the smart furniture control signal.

2. The system of claim 1,
wherein the control circuitry is configured such that, in response to the smart furniture control signal indicating an operation of moving a first movable part from among the one or more movable parts of the first furniture member to a first position, the control circuitry drives the actuator such that the first movable part moves to the first position.

3. The system of claim 1,
further comprising a memory,
wherein the control circuitry is configured such that, in response to the smart furniture control signal indicating an operation of storing at least one current position of at least one movable part from among the one or more movable parts of the first furniture member as a preset, the control circuitry stores the at least one current position of the at least one movable part as a preset in the memory.

4. The system of claim 1,
wherein the control circuitry is configured such that, in response to the smart furniture control signal indicating a stop motion operation, the control circuitry stops driving the actuator such that movement of the one or more movable parts of the first furniture member ceases.

5. The system of claim 1,
wherein the control circuitry is configured such that, in response to the smart furniture control signal indicating an operation of finding a remote, the control circuitry transmits, to the remote, a signal for causing the remote to generate an audible sound and/or a visible flashing light pattern.

6. A smart furniture member comprising:
a seatback;
a seat bottom;
a frame;
at least one movable legrest platform, headrest platform, lumbar platform, or back recline mechanism that is supported by the frame and movable relative to the frame; and
the smart furniture motion control system of claim 1,
wherein the smart furniture member is the first furniture member.

7. The smart furniture member of claim 6,
wherein the furniture member further comprises a heater, and
wherein the control circuitry is configured such that, in response to the smart furniture control signal indicating an operation of starting a heating function, the control circuitry controls the heater to turn on.

8. The smart furniture member of claim 7, wherein the control circuitry is configured such that, in response to the smart furniture control signal indicating an operation of controlling a level of the heating function, the control circuitry controls the heater to adjust the level of the heating function.

9. The smart furniture member of claim 6,
wherein the furniture member further comprises a massager, and
wherein the control circuitry is configured such that, in response to the smart furniture control signal indicating an operation of starting a massage function, the control circuitry controls the massager to turn on.

10. The smart furniture member of claim 9, wherein the control circuitry is configured such that, in response to the smart furniture control signal indicating an operation of controlling a level of the massage function, the control circuitry controls the massager to control an intensity of the massage function.

11. The smart furniture member of claim 9, wherein the control circuitry is configured such that, in response to the smart furniture control signal indicating an operation of providing the massage function with a specified massage pattern from among a plurality of different massage patterns, the control circuitry controls the massager to provide the massage function with the specified massage pattern.

12. A cloud network comprising:
memory storing computer-executable instructions; and
one or more processors configured to execute the computer-executable instructions, wherein the computer-executable instructions include,
receiving a first command indicating a requested operation of a smart furniture member;
generating, based on the requested operation of the first command, one or more smart furniture control signals for controlling the smart furniture member; and
transmitting the one or more smart furniture control signals to the smart furniture member.

13. The cloud network or claim 12, wherein the receiving of the first command includes receiving the first command via the internet.

14. The cloud network of claim 13, wherein the first command is an app command received from a user device running a smart furniture app.

15. The cloud network of claim 13, wherein the first command is a voice command received from a virtual assistant device.

16. The cloud network of claim 12 wherein the transmitting of the one or more smart furniture control signals to the smart furniture member includes transmitting the one or more smart furniture control signals to the smart furniture member via the internet.

17. The cloud network of claim 12,
wherein the generated one or more smart furniture control signals are control signals for controlling the smart furniture member to move a first movable part, from among one or more movable parts of the smart furniture member, to a first position, and
wherein the first movable part and the first position are indicated by the first command.

18. The cloud network of claim 12,
wherein the generated one or more smart furniture control signals are control signals for controlling the smart furniture member to store at least one current position of at least one movable part from among one or more movable parts of the smart furniture member as a preset in a memory of the smart furniture member.

19. The cloud network of claim 12,
wherein the generated one or more smart furniture control signals are control signals for controlling the smart furniture member to cease movement of one or more movable parts of the smart furniture member.

20. The cloud network of claim 12,
wherein the generated one or more smart furniture control signals are control signals for controlling the smart furniture member to perform a remote finding operation.

21. The cloud network of claim 12,
wherein the generated one or more smart furniture control signals are control signals for controlling the smart furniture member to start a heating function.

22. The cloud network of claim 21, wherein the one or more smart furniture control signals indicate an operation of controlling a level of the heating function.

23. The cloud network of claim 12,
wherein the generated one or more smart furniture control signals are control signals for controlling the smart furniture member to start a massage function.

24. The cloud network of claim 23, wherein the one or more smart furniture control signals indicate an operation of controlling a level of the massage function.

25. The cloud network of claim 23, wherein the one or more smart furniture control signals indicate an operation of providing the massage function with a specified massage pattern from among a plurality of different massage patterns.

26. The cloud network of claim 12 wherein computer-executable instructions include: displaying, on a mobile device, a status of the smart furniture member.

27. The cloud network of claim 26 wherein the status of the smart furniture member includes one or more of:
a battery status,
positions of components of the smart furniture member,
a wireless connectivity status of the furniture member,
a status of a do-not-disturb feature,
a power status of the furniture member indicating whether the furniture member is connected to a power source, and
a wireless connectivity status of the furniture member.
